(19) United States
(12) Patent Application Publication
(10) Pub. No.: US 2025/0081028 A1
(43) Pub. Date: Mar. 6, 2025

(54) METHOD AND SYSTEM FOR LOW LATENCY LOW LOSS SCALABLE THROUGHPUT SERVICE

(71) Applicant: Verizon Patent and Licensing Inc., Basking Ridge, NJ (US)

(72) Inventors: Ye Huang, San Ramon, CA (US); Jin Yang, Orinda, CA (US); Sudhakar Reddy Patil, Flower Mound, TX (US); Ali Imdad Malik, East Brunswick, NJ (US); Ravi Potluri, Coppell, TX (US)

(21) Appl. No.: 18/460,824

(22) Filed: Sep. 5, 2023

(51) Int. Cl. H04W 28/02; H04W 28/08; H04W 28/18

(52) U.S. Cl. CPC H04W 28/0273; H04W 28/0967; H04W 28/18

(57) ABSTRACT

A method, a network device, and a non-transitory computer-readable storage medium are described in relation to an LAS service. The LAS service may include enablement or disablement of the LA service subsequent to an establishment and active traffic flow associated with an application session. The LAS service may be enabled or disabled based on performance metric criteria and threshold values not being satisfied or being satisfied. The LAS service may be implemented to include an exposure function.

### BACKGROUND

Development and design of networks present certain challenges from a network-side perspective and an end device perspective. For example, Next Generation (NG) wireless networks, such as Fifth Generation New Radio (5G NR) networks are being deployed and are under development. End devices may connect to a radio access network according to various types of configurations and may be afforded different quality of service (QOS) levels. Various mechanisms and technologies may be used to ensure the delivery of certain performance metrics, such as minimal latency and packet loss, as well as high throughput and other types of network performance criteria.

### BRIEF DESCRIPTION OF THE DRAWINGS

FIG. 1 is a diagram illustrating an exemplary environment in which an exemplary embodiment of an L4S service may be implemented;

FIG. 2 is a diagram illustrating another exemplary environment in which an exemplary embodiment of the L4S service may be implemented;

FIGS. 3A and 3B are diagrams illustrating an exemplary process of an exemplary embodiment of the L4S service according to an exemplary scenario;

FIG. 4 is a diagram illustrating exemplary components of a device that may correspond to one or more of the devices illustrated and described herein; and

FIG. 5 is a flow diagram illustrating an exemplary process of an exemplary embodiment of the L4S service.

### DETAILED DESCRIPTION

The following detailed description refers to the accompanying drawings. The same reference numbers in different drawings may identify the same or similar elements. Also, the following detailed description does not limit the invention.

Low latency, low loss, and scalable throughput (L4S) is a technology whose aim is to drastically reduce latency experienced by packets traveling across the Internet and support high throughput. L4S may provide fast rate adaptation management and may reduce network congestion, queuing, and packet loss. An L4S service may, for example, use an Explicit Congestion Notification (ECN) scheme at the Internet Protocol (IP) layer.

While the L4S service may benefit users of a network (e.g., a mobile network or the like), implementation of the L4S service presents some difficulties and/or drawbacks. For example, there are challenges for network devices that may host application services (e.g., an application server (AS), an application function (AF), or the like) to request L4S service via network application programming interface (API) integration. For example, the AF may need to include business logic to discern and/or select which traffic flow may need to apply an L4S service and which traffic flow may not need the L4S service. Alternatively, the AF may apply the L4S service to all traffic flows which may be resource intensive. Additionally, the L4S service can be expensive to enable as a part of a dedicated bearer operation in the radio access network (RAN) as well as handling the L4S service in the RAN. For example, the provisioning and application of the L4S can be resource intensive in relation to the abundance of traffic flows that traverse the RAN. Further, in most cases, a 5G network may satisfy performance metrics associated with L4S, such as low latency, low packet loss, and high throughput, without the use of the L4S service.

According to exemplary embodiments, an L4S service is described herein. The L4S service may be applied to a wireless environment. For example, the wireless environment may include a Fourth Generation (4G) wireless environment, a 5G wireless environment, and/or a future generation wireless environment, as described herein.

According to an exemplary embodiment, an exposure function, such as a network exposure function (NEF), a service capability exposure function (SCEF), or the like, or another type of function or network device (referred to herein as simply a NEF) may include logic of the L4S service, as described herein. According to an exemplary embodiment, in response to a request (e.g., from an AF or the like) to create a traffic flow with a service level agreement (SLA) metric (e.g., low latency, low packet loss, high throughput, and/or another combination of performance metrics), the NEF may correlate or map the SLA to a policy pertaining to a parameter and a parameter value for a dedicated bearer. For example, the parameter and parameter value may include a 5G QoS identifier (5QI) value, a QoS class identifier (QCI), a radio access technology (RAT) Frequency Selection Priority (RFSP), which may include parameters and parameter values relating to signal quality, network load, user priority, coverage and capacity, mobility, etc., and/or another SLA-based metric.

According to an exemplary embodiment, the NEF may invoke the creation of the dedicated bearer in accordance with the policy and parameters, as well as enable traffic flow monitoring. For example, the traffic flow monitoring may include monitoring pertaining to delay, packet loss, and uplink (UL) and/or downlink (DL) bandwidth. The traffic flow monitoring configuration may include threshold values (e.g., packet loss threshold value, delay threshold value, etc.) and a request to be notified when a threshold value is not satisfied.

According to an exemplary embodiment, in response to receiving a notification that the threshold value is not satisfied, the NEF may invoke an update to the application session, the traffic flow, a QoS flow, a dedicated bearer, or the like. For example, the update may include causing a RAN device, such as a next generation Node B (gNB), an evolved Node B (eNB), or the like, and/or a core network device, such as user plane function (UPF), a packet gateway (PGW), or the like, to enable L4S detection, start congestion detection, and L4S marking on packets. According to some exemplary embodiments, the NEF may also notify the AF regarding the unsatisfied threshold value. The NEF may further request the AF to reduce a DL data rate without L4S enablement.

According to other exemplary embodiments, the NEF may further request the AF to enable L4S service. In this way, if the AF has not already enabled the L4S service (e.g., as a default), the AF may be able to process any L4S feedback packets of the application session or traffic flow of relevance.

According to some exemplary embodiments, the NEF may query a subscription device, as described herein, for subscription information pertaining to an end device associated with the application session or traffic flow. For example, the NEF may verify or determine whether the end device is subscribed to the L4S service.

According to an exemplary embodiment, a RAN device and/or a core network device may include logic of the L4S service, as described herein. For example, the RAN device and/or the core network device may be enabled to provide the L4S, as described herein, for an existing dedicated bearer.

In view of the foregoing, the L4S service may improve the provisioning of the L4S service. For example, the L4S service may be implemented without a request from an AF for the L4S service and avoids the challenges associated with requests via a network API. Additionally, for example, the L4S service may be invoked when SLA requirements are not being met instead of during the entire application session. The L4S service may further provide a mechanism to coordinate the AF with the RAN device and/or the core network device to provide the L4S service when invoked.

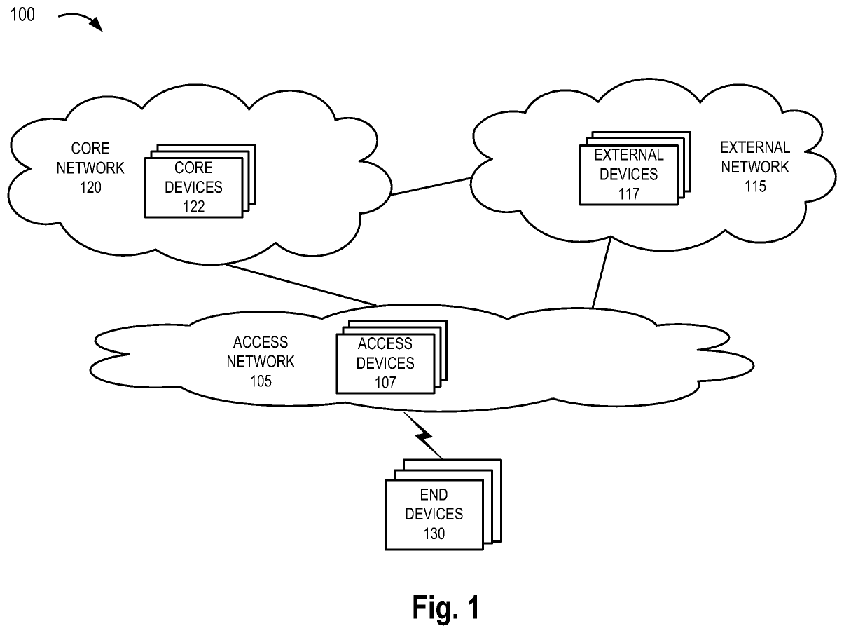

FIG. 1 is a diagram illustrating an exemplary environment 100 in which an exemplary embodiment of an L4S service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the L4S service may use at least one of these planes of communication.

Access network 105 may include one or multiple networks of one or multiple types and technologies. For example, access network 105 may be implemented to include a 5G RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 105 may include a legacy RAN (e.g., a Third Generation (3G) RAN, a 4G or 4.5 RAN, etc.). Access network 105 may communicate with and/or include other types of access networks, such as, for example, a Wi-Fi network, a Worldwide Interoperability for Microwave Access (WiMAX) network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120 including an Evolved Packet Core (EPC) network and/or an NG core (NGC) network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (COMP), various duplex schemes (e.g., frequency division duplex (FDD), time division duplex (TDD), half-duplex FDD (H-FDD), etc.), and/or another type of connectivity service (e.g., NSA new radio (NR), SA NR, etc.).

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various exemplary embodiments, access network 105 may be implemented according to various wireless technologies (e.g., RATs, etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a gNB, an enhanced Long Term Evolution (eLTE) eNB, an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a WiMax device, a hotspot device, a fixed wireless access CPE (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to some exemplary implementations, access device 107 may include a combined functionality of multiple RATs (e.g., 4G and 5G functionality, 5G and 5.5G functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to an exemplary embodiment, at least some of access devices 107 may include logic of an exemplary embodiment of the L4S service. For example, a gNB, an eNB, an eLTE eNB, or another kind of wireless station may enable an exemplary embodiment of the L4S service for an established dedicated bearer that may be supporting an application session, a traffic flow, a QoS flow, and/or the like, as described herein. The enablement of the L4S service may be based on receipt of an update message, as described herein. For example, a mobility management entity (MME), an access and mobility management function (AMF), or a similar functioning network device may transmit the update message to access device 107, as described herein.

External network 115 may include one or multiple networks of one or multiple types and technologies that provide an application service. For example, external network 115 may be implemented using one or multiple technologies including, for example, network function virtualization (NFV), SDN, cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

According to an exemplary embodiment, at least some of external devices 117 may include logic of the L4S service. For example, an AF, an AS, a MEC server, an IP server, an Internet or Web server, or a similar network device that may host an application service (also referred to simply as an AF) may provide an exemplary embodiment of the L4S service, as described herein. According to an exemplary embodiment, the AF may receive a notification that a threshold value associated with a performance metric and an ongoing application session or traffic flow is not satisfied, and in response, enable the L4S service, as described herein. According to another exemplary embodiment, the AF may receive a notification that a threshold value associated with a performance metric and an ongoing application session or traffic flow is not satisfied, and in response, reduce a data rate of the application session or traffic flow without enabling the L4S service.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a UPF, a Non-3GPP Interworking Function (N3IWF), an AMF, a session management function (SMF), a unified data management (UDM) device, a unified data repository (UDR), an authentication server function (AUSF), a security anchor function (SEAF), a network slice selection function (NSSF), a network repository function (NRF), a policy control function (PCF), a network data analytics function (NWDAF), a NEF, a SCEF, a lifecycle management (LCM) device, an MME, a PGW, an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 may include logic of the L4S service. For example, a NEF, an SCEF, or a similar functioning network device (also referred to simply as a NEF) may provide an exemplary embodiment of the L4S service, as described herein. The NEF may invoke the creation of a dedicated bearer in accordance with a network policy and parameters, as well as enable traffic flow monitoring, which may include monitoring pertaining to delay, packet loss, UL and/or DL bandwidth, and/or other configurable performance metrics, key performance indicators (KPIs), Quality of

Experience (QoE) parameters and values, Mean Opinion Score (MOS) parameters and values, such as data volume (e.g., maximum, minimum, etc.), packet error, bit rates (e.g., guaranteed, maximum, minimum, burst, aggregated maximum, etc.), retries, and so forth, as described herein. The traffic flow monitoring configuration may include threshold values (e.g., packet loss threshold value, delay threshold value, etc.) and a request to be notified when a threshold value is not satisfied.

According to an exemplary embodiment, the NEF may invoke an update to the application session, traffic flow, QoS flow, dedicated bearer and/or the like. For example, the update may include causing access device 107 and/or core device 122 to enable L4S detection, start congestion detection, and L4S marking on packets. According to some exemplary embodiments, the NEF may also notify the AF regarding the unsatisfied threshold value. The NEF may further request the AF to reduce a DL data rate without L4S enablement. According to other exemplary embodiments, the NEF may further request the AF to enable L4S service. In this way, if the AF has not already enabled the L4S service (e.g., as a default), the AF may be able to process any L4S feedback packets of the application session or traffic flow of relevance. According to some exemplary embodiments, the NEF may query a subscription device, as described herein, for subscription information pertaining to an end device associated with the application session or traffic flow. For example, the NEF may verify or determine whether end device 130 is subscribed to the L4S service.

End device 130 may include a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, a smart device, a fixed wireless device, a router, a sensor, an automated guided vehicle (AGV), an industrial robot, or other type of wireless device (e.g., other type of user equipment (UE)). End device 130 may be configured to execute various types of software (e.g., applications, programs, etc.). The number and the types of software may vary among end devices 130. End device 130 may include “edge-aware” and/or “edge-unaware” application service clients. For purposes of description, end device 130 is not considered a network device. End device 130 may be implemented as a virtualized device in whole or in part.

According to an exemplary embodiment, end device 130 may include logic of an exemplary embodiment of the L4S service. For example, end device 130 may provide L4S feedback regarding the application session or traffic flow, as described herein.

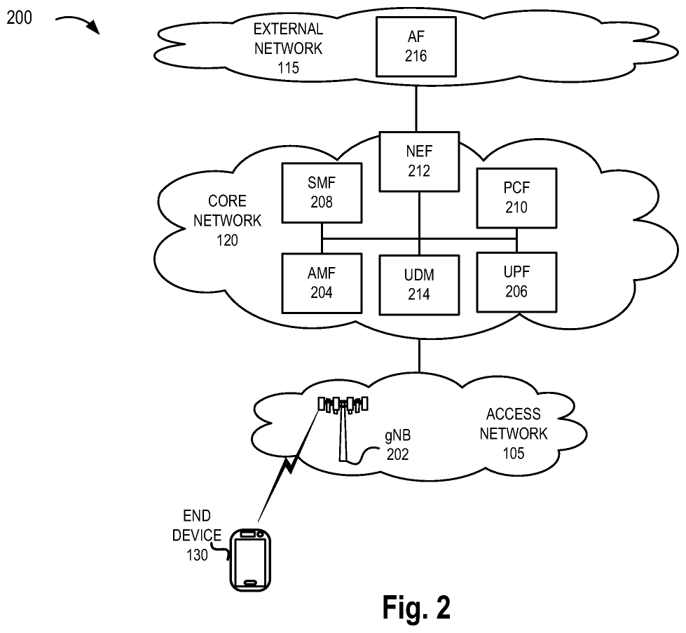

FIG. 2 is a diagram illustrating another exemplary environment in which an exemplary embodiment of the L4S service may be implemented. As illustrated, exemplary environment 200 may include a gNB 202, an AMF 204, a UPF 206, an SMF 208, a PCF 210, a NEF 212, a UDM 214, an AF 216, and end device 130. gNB 202 is an exemplary implementation of access device 107. AMF 204, UPF 206, SMF 208, PCF 210, NEF 212, and UDM 214 are exemplary implementations of core devices 122. AF 216 is an exemplary implementation of external device 117.

gNB 202, AMF 204, UPF 206, SMF 208, PCF 210, NEF 212, and/or UDM 214 may each provide a function and/or a service in accordance with a network standard, such as Third Generation Partnership Project (3GPP), 3GPP2, International Telecommunication Union (ITU), European Telecommunications Standards Institute (ETSI), GSM Association (GSMA), and the like and/or of a proprietary nature. For example, gNB 202 may include a radio node that enables end device 130 to connect with core network 120 using a 5G air interface. gNB 202 may provide user plane and control plane terminations towards end device 130. gNB 202 may include CU, DU, and RU functions that provide for mobility control, radio resource management (RRM), session management (SM), packet processing, and physical and MAC layer functionalities, among other functions.

AMF 204 may provide registration, connection, reachability, and mobility management, security context management, location service management, UE mobility event notification, among other functions. UPF 206 may provide an external PDU session point of interconnect to external network 115 (e.g., a data network, etc.), provide packet routing and forwarding, packet inspection, user plane policy rule enforcement, traffic usage reporting, QoS handling for user plane, among other functions. SMF 208 may provide session management, Internet Protocol (IP) address allocation and management, selection, and control of user plane (UP) function, configuration of traffic steering, control of policy enforcement and QoS, among other functions. PCF 210 may provide policies/rules to control plane network devices, make policy decisions based on subscription information, among other functions. NEF 212 may provide secure exposure to services, capabilities, and resources over APIs within and outside of core network 120, perform packet filter description (PFD) management procedures, translate information and allow third party network devices to access core network devices and vice versa, among other functions. UDM 214 may provide authentication, access authorization based on subscription data, subscription management, support to service/session continuity, among other functions.

According to an exemplary embodiment, gNB 202, AMF 204, UPF 206, SMF 208, PCF 210, NEF 212, and UDM 214 may include logic of an exemplary embodiment of the L4S service and/or provide support for a process of the L4S service, as described herein.

AF 216 may host an application service that may be used by end device 130.

Environment 200 is exemplary and according to other embodiments, environment 200 may include additional, different, and/or fewer network devices. For example, according to other exemplary embodiments, access network 105, core network 120, and/or external network 115 may include another type of access device 107, core device 122, and/or external device 117 than those illustrated and described in relation to FIG. 2.

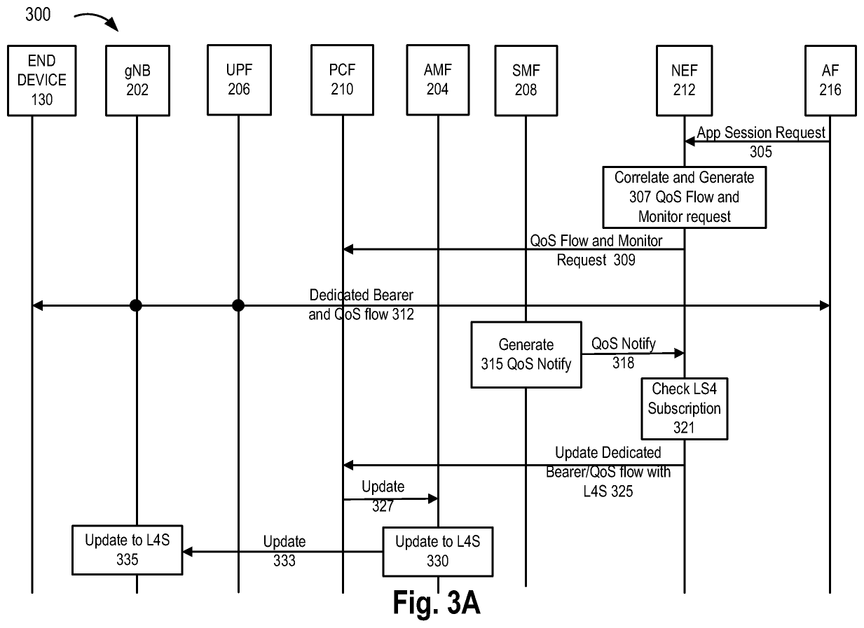

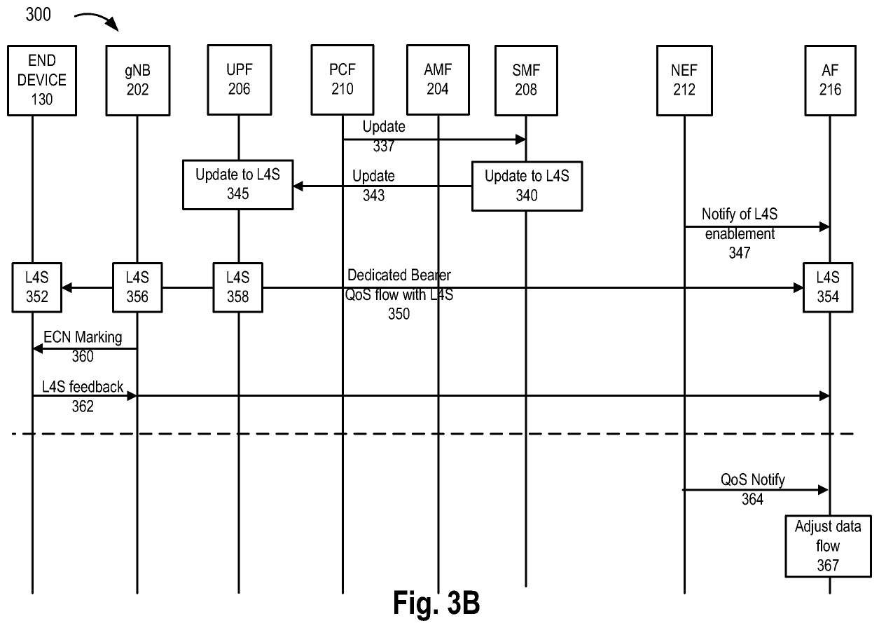

FIGS. 3A and 3B are diagrams illustrating an exemplary process 300 of an exemplary embodiment of the L4S service according to an exemplary scenario. For purposes of description, process 300 is described in relation to environment 200.

Referring to FIG. 3A, according to an exemplary scenario, AF 216 may generate and transmit an application session request 305 to NEF 212. Application session request 305 may pertain to end device 130. Application session request 305 may include various types of information, which may include a request of a traffic flow with a certain SLA requirement. According to one example, the SLA requirement may include low latency, low packet loss, and high throughput. According to another example, the SLA requirement may be different, such as low latency, low latency and low packet loss, low latency and high throughput, or the like. The SLA requirement may specify other types of performance metrics (e.g., jitter, priority level, maximum data burst volume, default averaging window, etc.). According to an exemplary scenario, application session request 305 may not include a request for an L4S service.

In response to receiving application session request 305, NEF 212 may correlate information included in application session request 305 to policies and parameters stored by NEF 212. The policies and parameters may include internal or core network SLA policies and associated parameters, parameter values, threshold values, and the like. NEF 212 may correlate and match the requested SLA requirement to a stored policy and parameters. For example, the selected stored policy may include a 5QI value, an RFSP, and/or another SLA-based metric. Based on the successful match and selection of a correlated policy and parameters, NEF 212 may generate 307 a QoS flow and monitor request 309. NEF 212 may transmit QoS flow and monitor request 309 to PCF 210. QoS flow and monitor request 309 may include the correlated policy and parameters and a request to monitor the SLA of the prospective traffic flow between end device 130 and AF 216. The monitoring service may also include notifying NEF 212 (and/or other core devices 122) when the SLA requirement is not being satisfied (e.g., based on an SLA threshold value, such as a latency threshold value, etc.). In response to receiving QoS flow, PCF 210 may initiate the creation of a dedicated bearer. For purposes of brevity, the dedicated bearer activation procedure is not illustrated or described. The dedicated bearer activation procedure may be initiated based on a determination that end device 130 does not have an existing bearer that may support the SLA requirement. As an example, end device 130 may have a default QoS flow or a default bearer established, which may not support the SLA requirement.

The dedicated bearer activation procedure may create a dedicated bearer based on the QoS flow and monitor request 309. The dedicated bearer activation procedure may involve communication between PCF 210, SMF 208, UPF 206, and so forth. As illustrated, as a result of a successful execution of the dedicated bearer activation procedure (and a session establishment procedure, also not illustrated), a dedicated bearer and QoS flow 312 may be established between end device 130 and AF 216. According to an exemplary embodiment, dedicated bearer and QoS flow 312 may not have L4S enabled or may not provide an L4S service. According to an exemplary scenario, the dedicated bearer and QoS flow 312 may be configured to support a time critical application (e.g., multiplayer gaming, cloud VR, drone, automotive V2X, etc.), for example.

According to an exemplary scenario, assume that during the application session, an SLA requirement is not being satisfied. For example, UPF 206 may detect that the SLA requirement of the traffic flow/QoS flow/application session is not being satisfied. Based on this detected event, UPF 206 may notify SMF 208. In response, SMF 208 may generate 315 a QoS notify message and transmit a QoS notify 318 to NEF 212. For example, QoS notify 318 may indicate that one or multiple SLA requirements are not being satisfied (e.g., relative to a threshold value). In response to receiving QoS notify 318, according to an exemplary implementation, NEF 212 may determine whether end device 130 is subscribed to the L4S service. For example, although not illustrated, NEF 212 may check L4S subscription 321 regarding end device 130 by querying UDM 214. Based on the subscription information of end device 130, a response may indicate whether end device 130 is subscribed or not to the L4S service. According to other exemplary implementations, another core device 122 may make this determination, or the L4S subscription procedure may be omitted.

According to an exemplary scenario, assume that end device 130 is subscribed to the L4S service (e.g., based on subscription data stored in UDM 214), in response, NEF 212 may generate and transmit an update dedicated bearer/QoS flow with L4S 325 to PCF 210. For example, the dedicated bearer and/or QoS flow may be updated to include L4S detection and L4S marking of packets associated with a state of congestion. As an example, update dedicated bearer/QoS flow with L4S 325 may include context information pertaining to the flow and/or bearer (e.g., dedicated bearer identifier, QoS flow identifier, end device identifier, etc.) and a request to invoke the L4S service. As illustrated, as a part of the update procedure, according to an exemplary implementation, PCF 210 may transmit an update message 327 to AMF 204, in which AMF 204 may perform an update to L4S 330 procedure, and AMF 204 may transmit an update message 333 to gNB 202, which in turn may invoke gNB 202 to update to L4S 335. Referring to FIG. 3B, according to another exemplary implementation, PCF 210 may transmit an update message 337 to SMF 208, in which SMF 208 may perform an update to L4S 340 procedure, and SMF 208 may transmit an update message 343 to UPF 206, which in turn may invoke UPF 206 to update to L4S 345. According to still other exemplary implementations, PCF 210 may transmit an update to AMF 204 and SMF 208. According to some exemplary embodiments, depending on the severity of the degradation (e.g., relative to the SLA threshold value), NEF 212 or PCF 210 may determine whether L4S service is to be enabled at gNB 202 or UPF 206, or at gNB 202 and UPF 206. As an example, when the current SLA is below a secondary or critical threshold value, which differs from the threshold value, NEF 212 or PCF 210 may enable the L4S service at both gNB 202 and UPF 206 in order to isolate and address the congestion more readily.

NEF 212 may generate and transmit a notify of L4S enablement 347 to AF 216. For example, notification 347 may indicate to AF 216 to enable L4S to process L4S feedback packet and perform other L4S procedures (e.g., adjust transmission rate, scheduling, queue management, and/or another step that may facilitate that the SLA requirement is satisfied and maintained during the application session) if AF 216 had not already enabled L4S as a default operation with respect to the application session/QoS flow with end device 130. For purposes of illustration, after successful L4S enablement, a dedicated bearer, QoS flow with L4S 350 may be established between end device 130 and AF 216 in which L4S tasks/operations (e.g., an L4S 352 at end device 130, an L4S 354 at AF 216 and, an L4S 356 at gNB 202 and/or an L4S 358 at UPF 206) may be performed. For example, gNB 202 may insert an ECN marking 360 on one more packets is/are transmitted to end device 130, and end device 130 may provide L4S feedback packets 362 to gNB 202. Additionally, or alternatively, although not illustrated, UPF 206 may perform a similar task.

According to another exemplary scenario, as further illustrated in FIG. 3B, NEF 212 may generate and transmit a QoS notify 364 to AF 216. Similar to QoS notify 318, QoS notify 364 may indicate that one or multiple SLA requirements are not being satisfied (e.g., relative to a threshold value) associated with the application session/QoS flow. In response to receiving QoS notify 364, AF 216 may adjust the traffic flow 367 of the application session without L4S enablement at AF 216 and/or other network devices (e.g., gNB 202, UPF 206, etc.) and end device 130. NEF 212 may transmit QoS notify 364 to AF 216, in response to receiving QoS notify 318.

According to an exemplary implementation, the L4S service may include ECN. For example, the L4S service may use a codepoint (e.g., ECT (1) or “01” to indicate ECN-Capable Transport (L4S)) of the ECN codepoints and a codepoint (e.g., congestion experienced (CE) or “11”) to indicate congestion as an explicit congestion signal. ECN may use an active queue management (AQM) congestion detection algorithm in which signaling may indicate (e.g., with a CE-marked packet) to an end host (e.g., AF 216) of congestion. The L4S service, as described herein, may use other known ECN schemes in which packets may be marked according to configured ECN scheme/codepoints that provide feedback and assists in managing congestion events and support certain SLA requirements pertaining to a dedicated QoS flow, a network slice, a subnetwork slice (e.g., a RAN slice, a core slice, etc.), an application service session, a packet data unit (PDU) session, a dedicated bearer, and so forth, as described herein.

FIGS. 3A and 3B illustrate process 300 according to an exemplary scenario, however according to other exemplary scenarios and/or embodiments, process 300 may include additional, different, and/or fewer steps or operations pertaining to the L4S service, as described herein. For example, process 300 may include a disablement procedure subsequent to the enablement or invocation of the L4S service. In this way, the L4S service may be an on-demand service that may be turned on or turned off depending on its need and current state of the traffic flow, QoS flow, and the like. For example, referring to FIG. 3A, in step 315, when SMF 208 may be notified that the SLA requirements are satisfied, SMF 208 may determine (based on context information) that the L4S service is currently enabled. In response, SMF 208 may notify NEF 212 that the SLA is satisfied. In a procedure similar to that described herein, NEF 212 may generate and transmit an update message to PCF 210 to turn off the L4S service, and PCF 210 may invoke a disablement procedure of the L4S relative to AMF 204, SMF 208, or both. According to some exemplary embodiments, NEF 212 may wait a certain time period (e.g., to avoid repetitive enable/disable L4S service procedures to be executed) before invoking the disablement L4S procedure.

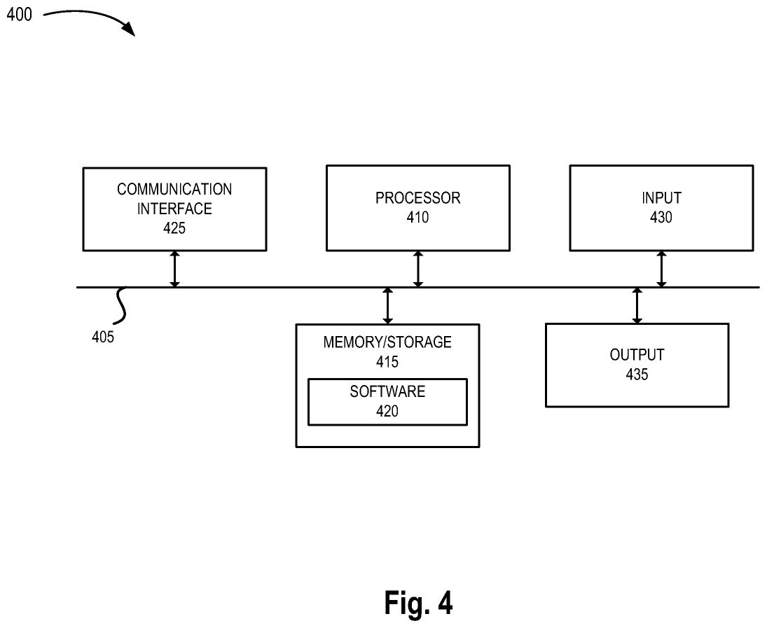

FIG. 4 is a diagram illustrating exemplary components of a device 400 that may be included in one or more of the devices described herein. For example, device 400 may correspond to access device 107, external device 117, core device 122, end device 130, and/or other types of devices, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques including, for example, multithreading, parallel processing, pipelining, interleaving, learning, model-based, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 415 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, mass storage, off-line storage, or some other type of storing medium. Memory/storage 415 may store data, software, and/or instructions related to the operation of device 400.

Software 420 includes an application or a program that provides a function and/or a process. As an example, with reference to core device 122 (e.g., NEF 212, etc.), software 420 may include an application that, when executed by processor 410, provides a function and/or a process of the L4S service, as described herein. According to another example, with reference to access device 107 (e.g., gNB 202, etc.), software 420 may include an application that, when executed by processor 410, provides a function and/or a process of the L4S service, as described herein. According to still another example, with reference to end device 130, software 420 may include an application that, when executed by processor 410, provides a function and/or a process of the L4S service, as described herein. Software 420 may also include firmware, middleware, microcode, hardware description language (HDL), and/or another form of instruction. Software 420 may also be virtualized. Software 420 may further include an operating system (OS) (e.g., Windows, Linux, Android, proprietary, etc.).

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers. Communication interface 425 may operate according to a protocol stack and a communication standard. Communication interface 425 may support one or multiple MIMO, beamforming, and/or transmission/reception configurations.

Input 430 permits an input into device 400. For example, input 430 may include a keyboard, a mouse, a display, a touchscreen, a touchless screen, a button, a switch, an input port, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 400 may be implemented in the same manner. For example, device 400 may be instantiated, created, deleted, or some other operational state during its life-cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 400 may be configured to perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 cause processor 410 to perform a function or a process described herein. Alternatively, for example, according to other implementations, device 400 may be configured to perform a function or a process described herein based on the execution of hardware (processor 410, etc.).

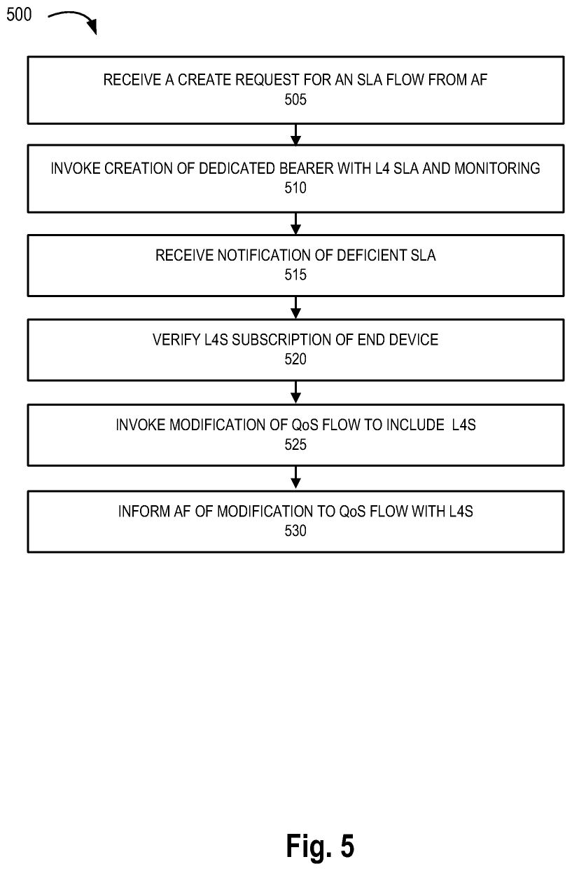

FIG. 5 is a flow diagram illustrating an exemplary process 500 of an exemplary embodiment of the L4S service. According to an exemplary embodiment, a function (e.g., a SCEF, NEF 212, or the like, or another type of network device) may perform process 500. According to an exemplary implementation, processor 410 executes software 420 to perform a step (in whole or in part) of process 500, as described herein. Alternatively, a step (in whole or in part) may be performed by execution of only hardware. For purposes of description only, process 500 is described as being performed by an exposure function (EF).

Referring to FIG. 5, in block 505, an EF may receive a create request, from an AF, for an SLA flow. According to an exemplary implementation, the SLA flow may pertain to an L4 SLA flow. According to another exemplary implementation, the SLA flow may pertain to a non-L4 SLA flow or a combination of a non-LA SLA metric and value and LA SLA metrics and values.

In block 510, in response to the create request from the AF, the EF may invoke the creation of a dedicated bearer with the SLA and monitoring. For example, the EF may invoke the creation of the dedicated bearer and requested SLA and monitoring based on mapping or correlation of the requested SLA to a policy pertaining to parameters and values for a dedicated bearer, as described herein.

In block 515, the EF may receive a notification of deficient SLA. For example, subsequent to the creation of the dedicated bearer, and active SLA flow, the EF may receive a notification from another core device that the SLA associated with the SLA is not satisfying the SLA criteria.

In block 520, the EF may verify L4S subscription of an end device. According to some exemplary implementations, the EF may verify that the end device is subscribed to the L4S service (e.g., based on a query to a UDM/UDR). According to other exemplary implementations, the EF may communicate with another core device (e.g., an AMF, an MME, or the like) to make the determination. For example, the AMF, the MME, or the like may query the UDM/UDR, the HSS, or the like, and provide the EF with a result of the query. According to still other exemplary implementations, block 520 may be omitted.

In block 525, the EF may invoke a modification to the QoS flow to include L4S. For example, when the end device is subscribed to the L4S service, or when the verification procedure is omitted, the EF may invoke the modification to the QoS flow, dedicated bearer, or the like. For example, the EF may communicate with another core device (e.g., a PCF or the like) and request that the traffic flow, the QoS flow, and/or the dedicated bearer provide the L4S service, as described herein.

In block 530, the EF may inform the AF of the modification to the QoS flow with L4S. For example, the EF may notify of the enablement of the L4S service relative to the QoS flow, the traffic flow, the dedicated bearer, or the like, as described herein.

FIG. 5 illustrates an exemplary process 500 of the L4S service, however, according to other exemplary embodiments, the L4S service may perform additional operations, fewer operations, and/or different operations than those illustrated and described in relation to FIG. 5. For example, the L4S service may include the disablement of the L4S service, as described herein.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the process illustrated in FIG. 5, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

The term “packet,” as used herein, is intended to be broadly interpreted to include a data transmission or communication, the packaging of which may correspond to, for example, a packet, a cell, a frame, a datagram, some other type of container or unit of data, and/or a fragment thereof.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a function from a network device, a request to create a traffic flow with low latency;
invoking, by the function responsive to the request, a creation of a dedicated bearer and associated monitoring that supports the traffic flow relative to an end device;
receiving, by the function after the creation of the dedicated bearer, a message indicating the low latency of the traffic flow is not satisfied; and
invoking, by the function, a modification to the dedicated bearer to include a low latency, low loss scalable throughput (L4S) service.

2. The method of claim 1, further comprising:
correlating, by the function, the request to a policy and parameters that provide for the dedicated bearer that supports the traffic flow with low latency.

3. The method of claim 1, further comprising:
verifying, by the function, that the end device is subscribed to the L4S service.

4. The method of claim 1, further comprising:
informing, by the function, the network device of the modification.

5. The method of claim 1, further comprising:
transmitting, by the function to the network device, the message.

6. The method of claim 1, wherein the traffic flow is created further with low packet loss and high throughput.

7. The method of claim 1, wherein the associated monitoring includes a threshold value for the low latency.

8. The method of claim 1, wherein the function includes a network exposure function (NEF) or a service capability exposure function (SCEF) of a core network, and the network device hosts an application service.

9. A network device comprising:
a processor that is configured to:
receive from another network device, a request to create a traffic flow with low latency;
invoke, responsive to the request, a creation of a dedicated bearer and associated monitoring that supports the traffic flow relative to an end device;
receive, after the creation of the dedicated bearer, a message indicating the low latency of the traffic flow is not satisfied; and
invoke a modification to the dedicated bearer to include a low latency, low loss scalable throughput (L4S) service.

10. The network device of claim 9, wherein the processor is further configured to:
correlate the request to a policy and parameters that provide for the dedicated bearer that supports the traffic flow with low latency.

11. The network device of claim 9, wherein the processor is further configured to:
verify that the end device is subscribed to the L4S service.

12. The network device of claim 9, wherein the processor is further configured to:
inform the network device of the modification.

13. The network device of claim 9, wherein the processor is further configured to:
transmit the message to the other network device.

14. The network device of claim 9, wherein the traffic flow is created further with low packet loss and high throughput.

15. The network device of claim 9, wherein the associated monitoring includes a threshold value for the low latency.

16. The network device of claim 9, wherein the network device includes a network exposure function (NEF) or a service capability exposure function (SCEF) of a core network, and the other network device hosts an application service.

17. A non-transitory computer-readable storage medium storing instructions executable by a processor of a network device, wherein the instructions are configured to:
receive from another network device, a request to create a traffic flow with low latency;
invoke, responsive to the request, a creation of a dedicated bearer and associated monitoring that supports the traffic flow relative to an end device;
receive, after the creation of the dedicated bearer, a message indicating the low latency of the traffic flow is not satisfied; and
invoke a modification to the dedicated bearer to include a low latency, low loss scalable throughput (L4S) service.

18. The non-transitory computer-readable storage medium of claim 17, wherein the instructions are further configured to:
correlate the request to a policy and parameters that provide for the dedicated bearer that supports the traffic flow with low latency.

19. The non-transitory computer-readable storage medium of claim 17, wherein the instructions are further configured to:
verify that the end device is subscribed to the L4S service.

20. The non-transitory computer-readable storage medium of claim 17, wherein the traffic flow is created further with low packet loss and high throughput.
